(19) United States
(12) Patent Application Publication
(10) Pub. No.: US 2014/0028668 A1
(43) Pub. Date: Jan. 30, 2014

(54) MULTIPLE SCISSOR PLANE REGISTERS FOR RENDERING IMAGE DATA

(71) Applicants: Xianchao James Xu, Beijing (CN); Lili Sophia Gong, Beijing (CN)

(72) Inventors: Xianchao James Xu, Beijing (CN); Lili Sophia Gong, Beijing (CN)

(21) Appl. No.: 13/977,505

(22) PCT Filed: Dec. 26, 2011
(86) PCT No.: PCT/CN2011/084627

§ 371 Date: Sep. 23, 2013

(51) Int. Cl. G06T 15/00

(52) U.S. Cl. CPC G06T 15/00
USPC 345/419

(57) ABSTRACT

Systems, apparatus, articles, and methods are described including operations to receive visible rectangle data indicating the portions of a three dimensional (3D) application being displayed. A determination of two or more scissor planes may be made based at least in part on the visible rectangle data. Two or more scissor plane registers may be set based at least in part on the determined two or more scissor planes. Image data may be rendered to a render buffer based at least in part on the determined two or more scissor planes.

### BACKGROUND

Currently, when a three dimensional (3D) application is going to redraw a window associated with the 3D application, a driver may draw all the screen data for the whole window associate with the 3D application and then block image transfer (BLIT) the visible content to the frame buffer. Because of the overlaps of different windows, some content rendered for the 3D application may not be displayed.

Currently, many GPUs support the scissor test function, which may be used to constrain the render happening in one desired area. In such a scissor test function, all the pixels out of the scissor area may be dropped from further processing during the scissor test.

Similarly, in a Linux-type windows system, the window of the 3D application may be drawable and may have visible information that may be stored as a clip rectangle. Typically, when the 3D application redraws its window, the visible part in the clip rectangles may be BLIT to a frame buffer.

In some application programming interfaces (APIs) (e.g., the OpenGL API and/or Direct3D API), a programmer may set the scissor plane. However, many GPUs support one scissor plane, representing one rectangle area. So a programmer may only set one active scissor plane.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example an graphics processing system;

FIG. 2 is a flow chart illustrating an example rendering process;

FIG. 3 is an illustrative diagram of an example graphics processing system in operation;

FIG. 4 is an illustrative diagram of an example an graphics processing system;

FIG. 5 is an illustrative diagram of an example system; and

FIG. 6 is an illustrative diagram of an example system, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

As will be described in greater detail below, some example implementation may include operations to receive visible rectangle data indicating the portions of a three dimensional (3D) application being displayed. A determination of two or more scissor planes may be made based at least in part on the visible rectangle data. Two or more scissor plane registers may be set based at least in part on the determined two or more scissor planes. Image data may be rendered to a render buffer based at least in part on the determined two or more scissor planes.

For example, a graphics processing unit (GPU) may be modified to support multiple scissors. Such multiple scissors may be used in conjunction with clip/visible information from a windows manager in the 3D rendering pipeline. For example, multiple scissors may be used to reduce unnecessary rendering, which may increase the 3D rendering performance and/or may also save the whole system power (e.g., when multiple scissors are used on smart phone/tablet platforms).

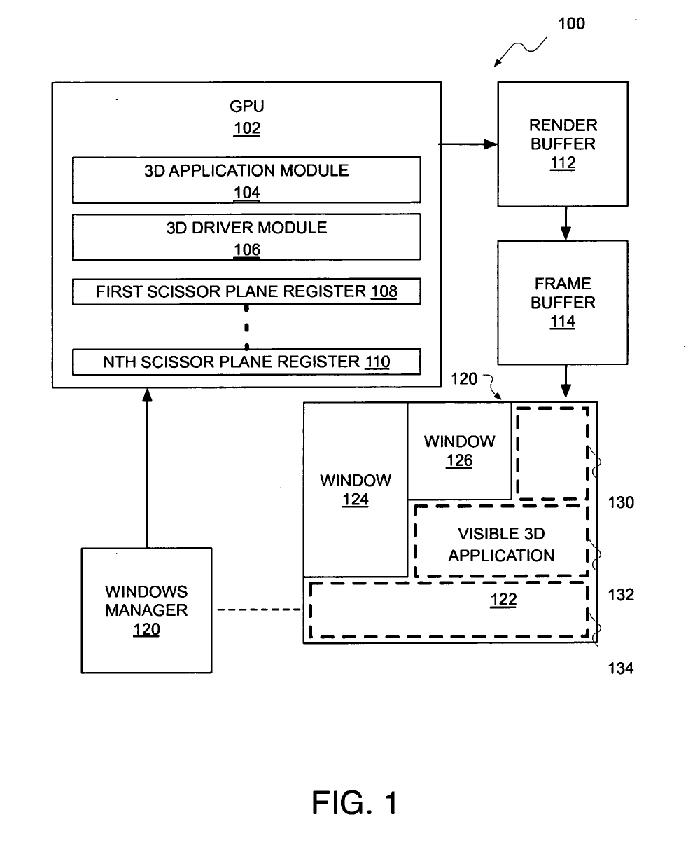

FIG. 1 is an illustrative diagram of a graphics processing system 100, arranged in accordance with at least some implementations of the present disclosure. In the illustrated implementation, graphics processing system 100 may include a graphics processing unit (GPU) 102, a windows manager 120, a render buffer 112 and/or a frame buffer 114. As illustrated, GPU 102, windows manager 120, render buffer 112 and/or frame buffer 114 may be capable of communication with one another. In some examples, graphics processing system 100 may include additional items that have not been shown in FIG. 1 for the sake of clarity. For example, graphics processing system 100 may include a radio frequency-type (RF) transceiver, an antenna a speaker, a display, an accelerometer, memory, a router, network interface logic, etc. that have not been shown in FIG. 1 for the sake of clarity.

In some implementations, graphic processing unit 102 may include a three dimensional (3D) application module 104, a 3D driver module 106, and/or the like. Additionally, graphic processing unit 102 may include two or more scissor plane registers, such as, a first scissor plane register 108 up to an Nth scissor plane register 110. In some examples, scissor plane registers 108/110 may be implemented as eight registers, sixteen plane registers, and/or the like.

In the illustrated example, a screen 120 may include a visible presentation 122 of 3D application module 104. Portions of 3D application module 104 may be obscured by one or more windows, such as window 124 and/or window 126. For example, window 124 might be associated with a second application different from 3D application module 104, while window 126 might be associated with a third application different from 3D application module 104.

In the illustrated example, visible presentation 122 of 3D application module 104 may be associated with one or more visible rectangles, such as visible rectangle 130, visible rectangle 132, visible rectangle 134, or more or less visible rectangles. For example, windows manager 120 may associate visible presentation 122 of 3D application module 104 with such one or more visible rectangles 130/132/134. In such an example, windows manager 120 may and generate visible rectangle data regarding such one or more visible rectangles 130/132/134.

In operation, graphic processing unit 102 may receive visible rectangle data from windows manager 120, where the visible rectangle data may indicate the portions 122 of 3D application module 104 being displayed. Graphic processing unit 102 may determine two or more scissor planes based at least in part on the visible rectangle data. Graphic processing unit 102 may set scissor plane registers 108/110 based at least in part on the determined scissor planes. Graphic processing unit 102 may render image data to render buffer 112 based at least in part on scissor plane registers 108/110. In some examples, the rendering of image data to render buffer 112 may involve rendering only image data that corresponds to scissor planes associated with scissor plane registers 108/110.

In operation, graphic processing unit 102 may support multiple scissor planes. In some implementations, 3D driver module 106 may use clip/visible information from window manager 120. For example, a function in 3D driver module 106 may be called before the rendering to get visible rectangle data from window manager 120. In response, 3D driver module 106 may set multiple scissor planes in the scissor planes registers 108/110 based at least in part on the visible rectangle data. For example, such multiple scissor planes may be enabled/disabled independently and may allow graphic processing unit 102 to remove the pixels outside of the active scissor planes during rendering.

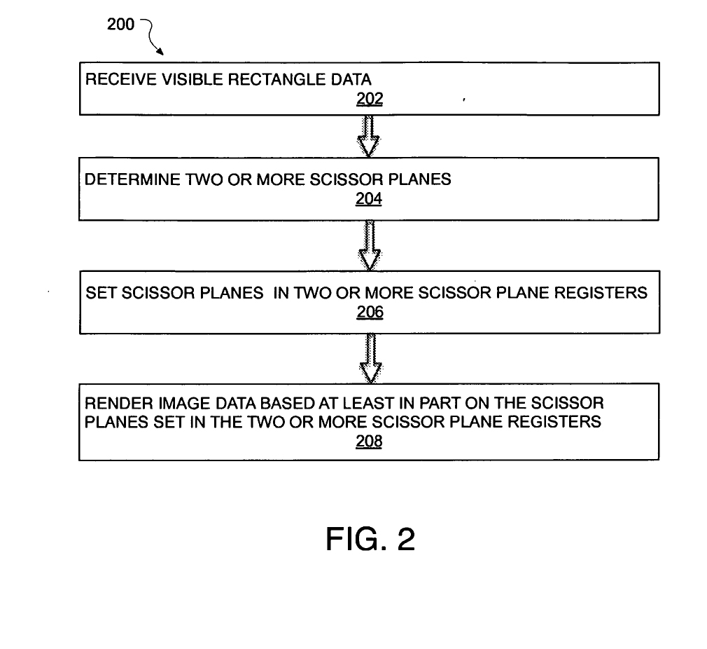

FIG. 2 is a flow chart illustrating an example rendering process 200, arranged in accordance with at least some implementations of the present disclosure. In the illustrated implementation, process 200 may include one or more operations, functions or actions as illustrated by one or more of blocks 202, 204, 206, and/or 208. By way of non-limiting example, process 200 will be described herein with reference to example graphics processing system 100 of FIG. 1.

Process 200 may begin at block 202, “RECEIVE VISIBLE RECTANGLE DATA”, where visible rectangle data may be received. For example, visible rectangle data may be received, via the graphic processing unit, from a windows manager. In some implementations, such visible rectangle data may indicate the portions of a three dimensional (3D) application being displayed.

Processing may continue from operation 202 to operation 204, “DETERMINE TWO OR MORE SCISSOR PLANES”, where two or more scissor planes may be determined. For example, two or more scissor planes may be determined, via the graphic processing unit, based at least in part on the visible rectangle data.

Processing may continue from operation 204 to operation 206, “SET SCISSOR PLANES IN TWO OR MORE SCISSOR PLANE REGISTERS”, where scissor planes may be set in two or more scissor plane registers. For example, the two or more scissor plane registers may be set, via the graphic processing unit, based at least in part on the determined two or more scissor planes.

Processing may continue from operation 206 to operation 208, “RENDER IMAGE DATA BASED AT LEAST IN PART ON THE SCISSOR PLANES SET IN THE TWO OR MORE SCISSOR PLANE REGISTERS”, where image data may be rendered based at least in part on the two or more scissor plane registers. For example, image data may be rendered, via the graphic processing unit, to a render buffer based at least in part on the two or more scissor plane registers. In some examples, the rendering of image data to the render buffer may involve rendering only image data that corresponds to the two or more scissor planes.

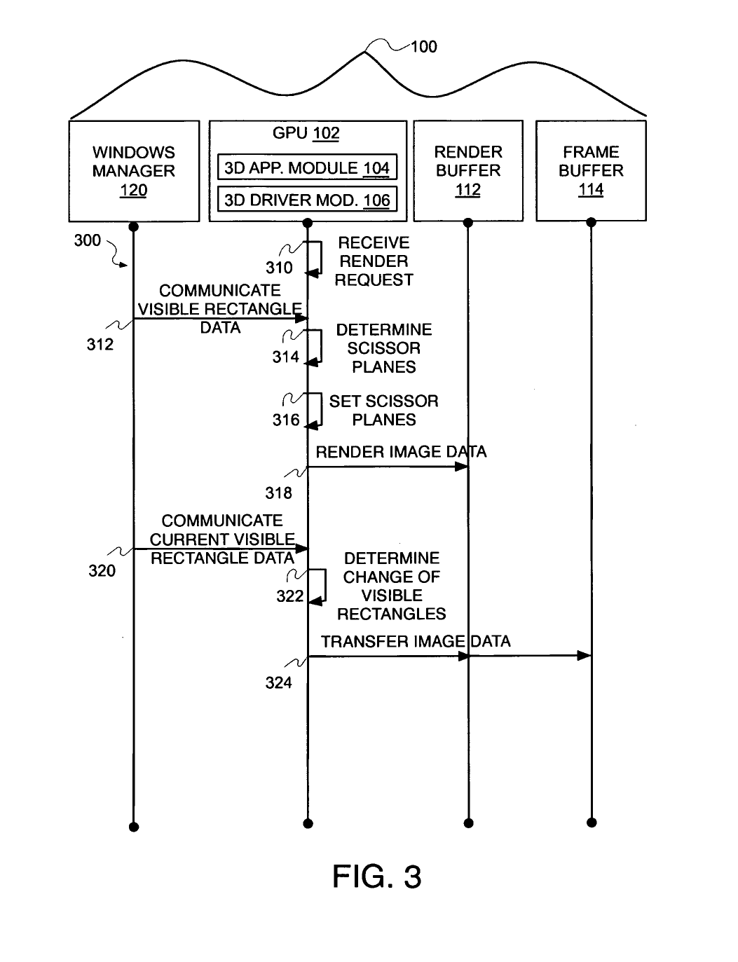

Some additional and/or alternative details related to process 200 may be illustrated in one or more examples of implementations discussed in greater detail below with regard to FIG. 3.

FIG. 3 is an illustrative diagram of example graphics processing system 100 and rendering process 300 in operation, arranged in accordance with at least some implementations of the present disclosure. In the illustrated implementation, process 300 may include one or more operations, functions or actions as illustrated by one or more of actions 310, 312, 314, 316, 318, 320, 322, and/or 324. By way of non-limiting example, process 300 will be described herein with reference to example graphics processing system 100 of FIG. 1.

In the illustrated implementation, graphics processing system 100 may include GPU 102, windows manager 120, render buffer 112 and/or frame buffer 114. As illustrated, GPU 102, windows manager 120, render buffer 112 and/or frame buffer 114 may be capable of communication with one another. Although graphics processing system 100, as shown in FIG. 3, may include one particular set of blocks or actions associated with particular modules, these blocks or actions may be associated with different modules than the particular module illustrated here.

Process 300 may begin at block 310, “RECEIVE RENDER REQUEST”, where a render request may be received. For example, a render request may be received from three dimensional (3D) application module 104, via 3D driver module 106.

Processing may continue from operation 310 to operation 312, “COMMUNICATE VISIBLE RECTANGLE DATA”, where visible rectangle data may be communicated. For example, visible rectangle data may be received, via graphic processing unit 102, from windows manager 120. In some implementations, such visible rectangle data may indicate the portions of 3D application module 104 being displayed.

In some implementations, such visible rectangle data may be pushed from windows manager 120. In other implementations, such visible rectangle data may be pulled from windows manager 120 by requesting (not illustrated), via 3D driver module 106, the visible rectangle data from windows manager 120. For example, such a request for visible rectangle data may be made in response to the render request of operation 310.

Processing may continue from operation 312 to operation 314, “DETERMINE SCISSOR PLANES”, where two or more scissor planes may be determined For example, two or more scissor planes may be determined, via 3D driver module 106, based at least in part on the visible rectangle data.

Processing may continue from operation 314 to operation 316, “SET SCISSOR PLANES”, where scissor planes may be set in two or more scissor plane registers. For example, the two or more scissor plane registers may be set, via 3D driver module 106, based at least in part on the determined two or more scissor planes.

Processing may continue from operation 316 to operation 318, “RENDER IMAGE DATA”, where image data may be rendered based at least in part on the two or more scissor plane registers. For example, image data may be rendered, via 3D driver module 106, to render buffer 112 based at least in part on the two or more scissor plane registers. In some examples, the rendering of image data to render buffer 112 may involve rendering only image data that corresponds to the two or more scissor planes.

Processing may continue from operation 318 to operation 320, “COMMUNICATE CURRENT VISIBLE RECTANGLE DATA”, where current visible rectangle data may be communicated. For example, the current visible rectangle data may be received, via graphic processing unit 102, from windows manager 120. In some implementations, such current visible rectangle data may indicate the portions of a three dimensional (3D) application being displayed.

In some implementations, such current visible rectangle data may be pushed from windows manager 120. In other implementations, such current visible rectangle data may be pulled from windows manager 120 by requesting (not illustrated), via 3D driver module 106, the visible rectangle data from windows manager 120. For example, such a request for current visible rectangle data may be made after the rendering of image data at operation 318.

Processing may continue from operation 320 to operation 322, “DETERMINE CHANGE OF VISIBLE RECTANGLES”, where a change of visible rectangles may be determined For example, a determination may be made, via 3D driver module 106, whether the current visible rectangle data have changed as compared to the visible rectangle data.

Processing may continue from operation 322 to operation 324, “TRANSFER IMAGE DATA”, where image data may be transferred. For example, the image data may be transferred via block image transfer (BLIT). In some implementations, the image data may be transferred, via 3D driver module 106, from render buffer 112 to frame buffer 114.

For example transferring the image data at operation 324 may be performed in response to a determination at operation 322 that the current visible rectangle data has not changed as compared to the visible rectangle data.

In addition to operations 310-324, process 300 may include other operations not illustrated in FIG. 3. For example, process 300 may repeat operations 314-318 in response to a determination at operation 322 that the current visible rectangle data has changed as compared to the visible rectangle data. In such an example, process 300 may repeat the determination of the two or more scissor planes at operation 314, the setting the two or more scissor plane registers at operation 316, an the rendering of image data to render buffer 312 at operation 318.

In operation, process 300 (and/or process 200) may result in 3D driver module 106 receiving a request (e.g., a glFlush/glSwapBuffer-type command) from 3D application module 104. In response, 3D driver module 106 may prepare a command buffer for 3D hardware. 3D driver module 106 may call a function to get the visible rectangle info from windows manager 120 and set the visible rectangles into the scissor plane registers GPU 102. In some implementations, window manager 120 may have the visible rectangle data for each window. For example, in X window, window manager 120 may store the visible rectangle data in clip rectangles of each drawable (e.g., in X windows, each window may be treated as one kind of drawable). 3D driver module 106 may request this visible rectangle data from windows manager 120 and adjust the scissor planes based at least in part on such visible rectangle data.

3D driver module 106 may then kick off the command buffer and start the 3D rendering. Next, 3D driver module 106 may call a function to get the current visible rectangle information from windows manager 120 again. 3D driver module 106 may compare the current visible rectangle information with the prior current visible rectangle information. Typically, in cases where the visible rectangle information does not change, render buffer 112 may be BLIT to frame buffer 114. Alternatively, in cases where the visible rectangle information changes, 3D driver module 106 may clear the scissor plane registers to re-draw render buffer 112 again, and then BLIT the updated render buffer 112 to frame buffer 114 according to the current visible rectangles. For example, in some conditions, the windows of 3D application module 104 or its overlapping windows may move or change during the rendering. If this change happens during the rendering, 3D driver module 106 may re-render the scene; otherwise 3D driver module 106 may go to BLIT directly. Because the render of each scene is typically very fast (normally a few milliseconds), the possibility of windows change during this rendering is very small. And often, the render request initiating process 300 may be triggered via a window change, so in many cases, a change in windows will go to BLIT directly.

While implementation of example processes 200 and 300, as illustrated in FIGS. 2 and 3, may include the undertaking of all blocks shown in the order illustrated, the present disclosure is not limited in this regard and, in various examples, implementation of processes 200 and 300 may include the undertaking only a subset of the blocks shown and/or in a different order than illustrated.

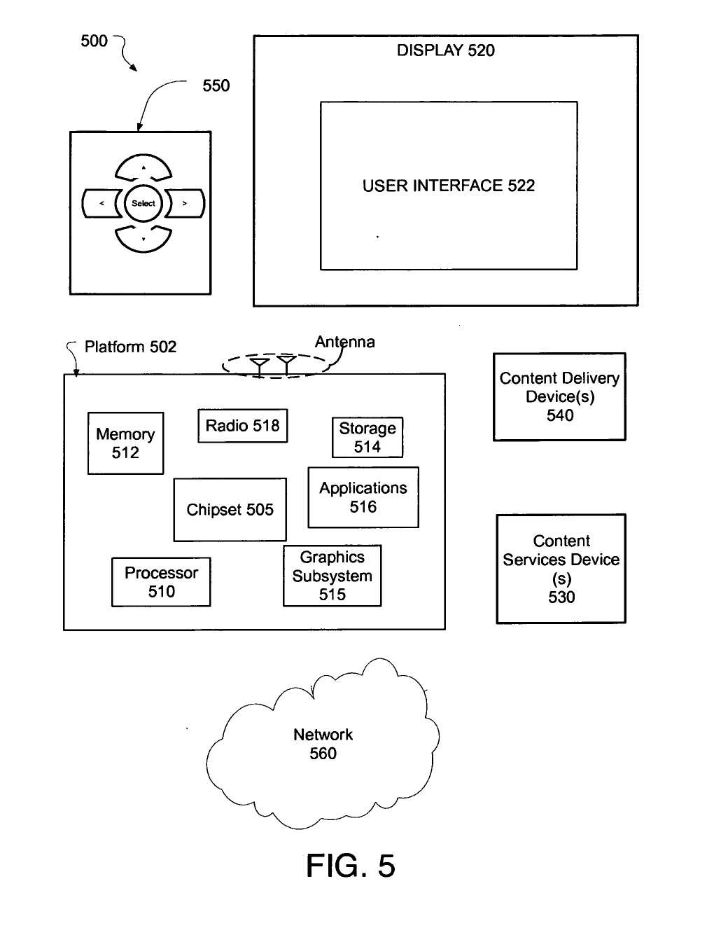

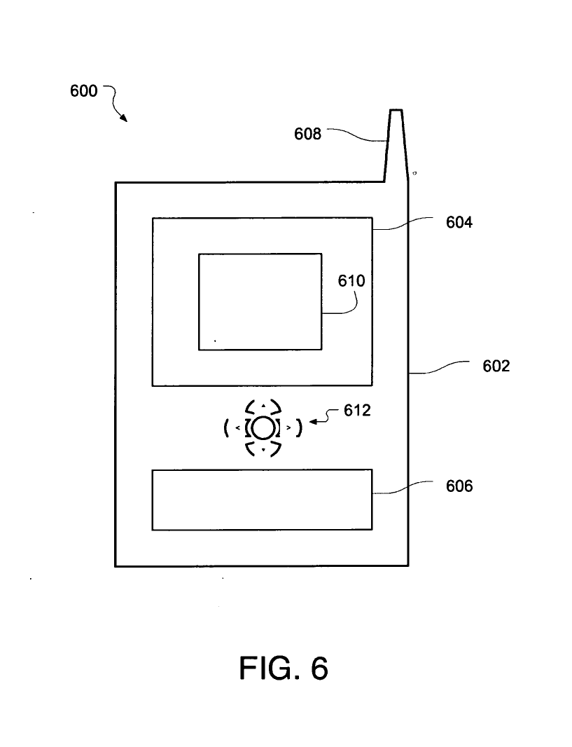

In addition, any one or more of the blocks of FIGS. 2 and 3 may be undertaken in response to instructions provided by one or more computer program products. Such program products may include signal bearing media providing instructions that, when executed by, for example, a processor, may provide the functionality described herein. The computer program products may be provided in any form of computer readable medium. Thus, for example, a processor including one or more processor core(s) may undertake one or more of the blocks shown in FIGS. 5 and 6 in response to instructions conveyed to the processor by a computer readable medium.

As used in any implementation described herein, the term “module” refers to any combination of software, firmware and/or hardware configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth.

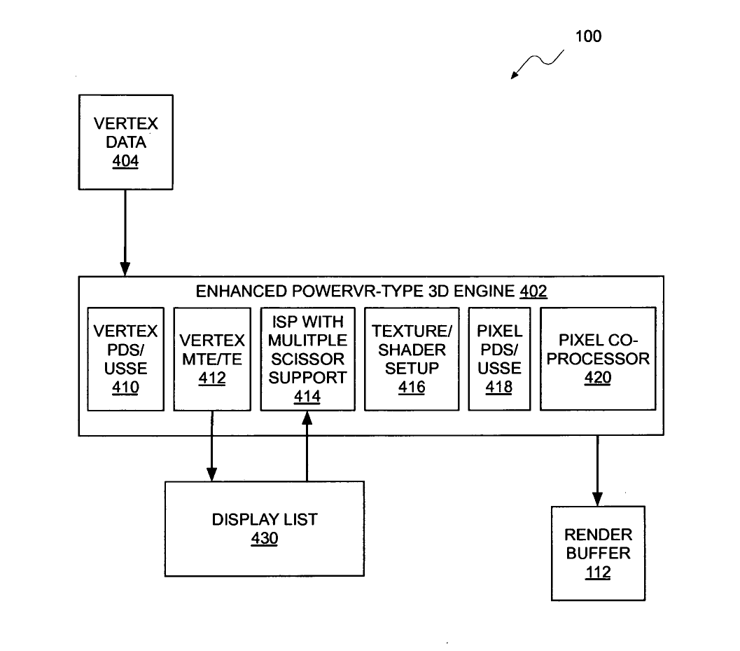

FIG. 4 is an illustrative diagram of another implementation of graphics processing system 100, arranged in accordance with at least some implementations of the present disclosure. In the illustrated implementation, graphics processing system 100 may include an enhanced PowerVR-type 3D Engine 402. Graphics processing system 100 disclosed herein could be applied to different GPUs and operating systems (OS). In the illustrated example, graphics processing system 100 will be described as utilizing enhanced PowerVR-type 3D Engine 402 and Linux system, as an example implementation of a 3D driver module logic path (see, e.g., 3D driver module 106 of FIG. 1).

In the illustrated implementation, enhanced PowerVR-type 3D Engine 402 may include vertex PDS/USSE (Programmable Data Sequencer/Universal Scalable Shader Engine) 410, a vertex MTE/TE (Macro Tiling Engine/Tiling Engine) 412, an ISP (Image Synthesis Processor) with multiple scissor support 414, a texture/shader setup module 416, a pixel PDS/USSE (Programmable Data Sequencer/Universal Scalable Shader Engine) 418, a pixel co-processor 420, the like, and/or combinations thereof In some examples, enhanced PowerVR-type 3D Engine 402 may include additional items that have not been shown in FIG. 4 for the sake of clarity.

In operation, enhanced PowerVR-type 3D Engine 402 may receive vertex data 404 and render image data to render buffer 112. For example, enhanced PowerVR-type 3D Engine 402 may perform a 3D rendering pipeline including a vertex pipeline to process vertex data 404 (e.g., geometry data, such as vector point data) to create the 3D data points in a scene to a 2D plane to be displayed.

More specially, vertex PDS/USSE 410 may perform vertex transformation and/or lighting. For example, the PDS portion of vertex PDS/USSE 410 may control hardware logic in enhanced PowerVR-type 3D Engine 402. For example, the PDS portion of vertex PDS/USSE 410 may fetch vertex data 404 and setup vertex/pixel shader programs. Additionally or alternatively, the USSE of vertex PDS/USSE 410 may instruct the hardware execution unit to run such a vertex/pixel shader program.

Further, vertex MTE/TE 412 may fulfill clip/viewport functions and output a display list (e.g., a tile-based output buffer of the vertex processing, which may be used as the input data for pixel processing). For example, the MTE portion of vertex MTE/TE 412 may perform a series of operation including viewport transformation, screen projection, clipping, and/or back face culling. Additionally or alternatively, the TE portion of vertex MTE/TE 412 may tiles the resultant data to create a display list in memory.

After VERTEX MTE/TE 412 is done working, the operations within 3D vertex phase may be completed. The generation result DISPLAY LIST 430 (which may contains 2D calculated data) may be sent to the pixel PDS/USSE 418 for further process that may occur in the 3D pixel phase such as texturing and fragment shading. For example, ISP 414 may perform the first stage of a pixel processing pipeline that performs the hidden surface removal. In some implementations, enhanced PowerVR-type 3D Engine 402 may support multiple scissors (e.g., eight scissor, sixteen scissor, or the like); each scissor may be associated with one plane and may be enabled and disabled independently. In such an example, only the pixel data associated with the active scissors may pass in this stage.

Further, texture/shader setup module 416 may produce the color and texture coordinates for each visible pixel, and prepare a shader to modify the pixels. Next, pixel PDS/USSE 418 may perform pixel processing. Lastly, pixel co-processor 420 may perform pixel blending/formatting and output image data to render buffer 112.

FIG. 5 illustrates an example system 500 in accordance with the present disclosure. In various implementations, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internes device (MID), messaging device, data communication device, and so forth.

In various implementations, system 500 includes a platform 502 coupled to a display 520. Platform 502 may receive content from a content device such as content services device(s) 530 or content delivery device(s) 540 or other similar content sources. A navigation controller 550 including one or more navigation features may be used to interact with, for example, platform 502 and/or display 520. Each of these components is described in greater detail below.

In various implementations, platform 502 may include any combination of a chipset 505, processor 510, memory 512, storage 514, graphics subsystem 515, applications 516 and/or radio 518. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 510 may be dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 514 may include technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 may be integrated into processor 510 or chipset 505. In some implementations, graphics subsystem 515 may be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 518 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In various implementations, display 520 may include any television type monitor or display. Display 520 may include, for example, a computer display screen, touch screen display, video monitor, television-like device, and/or a television. Display 520 may be digital and/or analog. In various implementations, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In various implementations, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In various implementations, content services device(s) 530 may include a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be replicated on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but may be integrated into platform 502 and/or display 520. The present disclosure, however, is not limited to the elements or in the context shown or described herein.

In various implementations, drivers (not shown) may include technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 even when the platform is turned “off” In addition, chipset 505 may include hardware and/or software support for (5.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the present disclosure.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As described above, system 500 may be embodied in varying physical styles or form factors. FIG. 6 illustrates implementations of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may include a housing 602, a display 604, an input/output (I/O) device 606, and an antenna 608. Device 600 also may include navigation features 612. Display 604 may include any suitable display unit for displaying information appropriate for a mobile computing device. I/O device 606 may include any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

1-28. (canceled)

29. A computer-implemented method, comprising:
receiving, via a graphic processing unit, visible rectangle data from a windows manager, wherein the visible rectangle data indicate the portions of a three dimensional (3D) application being displayed;
determining, via the graphic processing unit, two or more scissor planes based at least in part on the visible rectangle data;
setting, via the graphic processing unit, two or more scissor plane registers based at least in part on the determined two or more scissor planes; and
rendering, via the graphic processing unit, image data to a render buffer, wherein the rendering of image data is based at least in part on the two or more scissor plane registers.

30. The method of claim 29, wherein the rendering of image data to the render buffer comprises rendering only image data that corresponds to the two or more scissor planes.

31. The method of claim 29, wherein the two or more scissor plane registers comprise eight or more plane registers.

32. The method of claim 29, wherein the two or more scissor plane registers comprise sixteen or more plane registers.

33. The method of claim 29, further comprising:
receiving, via the graphic processing unit, a render request from the 3D application; and
requesting, via the graphic processing unit, the visible rectangle data from the windows manager.

34. The method of claim 29, further comprising:
receiving, via the graphic processing unit, current visible rectangle data from the windows manager; and
determining, via the graphic processing unit, whether the current visible rectangle data have changed as compared to the visible rectangle data.

35. The method of claim 29, further comprising:
receiving, via the graphic processing unit, current visible rectangle data from the windows manager;
determining, via the graphic processing unit, whether the current visible rectangle data have changed as compared to the visible rectangle data; and
transferring, via the graphic processing unit, the image data from the render buffer to a frame buffer in response to a determination that the current visible rectangle data has not changed as compared to the visible rectangle data.

36. The method of claim 29, further comprising:
receiving, via the graphic processing unit, current visible rectangle data from the windows manager;
determining, via the graphic processing unit, whether the current visible rectangle data have changed as compared to the visible rectangle data; and
repeating the determination of the two or more scissor planes, the setting the two or more scissor plane registers, an the rendering of image data to the render buffer in response to a determination that the current visible rectangle data has changed as compared to the visible rectangle data.

37. The method of claim 29, further comprising:
receiving, via the graphic processing unit, a render request from the 3D application;
requesting, via the graphic processing unit, the visible rectangle data from the windows manager;
requesting, via the graphic processing unit, current visible rectangle data from the windows manager after the rendering of image data to the render buffer;
receiving, via the graphic processing unit, the current visible rectangle data from the windows manager in response to the request for current visible rectangle data;
determining, via the graphic processing unit, whether the current visible rectangle data have changed as compared to the visible rectangle data;
transferring, via the graphic processing unit, the image data from the render buffer to a frame buffer in response to a determination that the current visible rectangle data has not changed as compared to the visible rectangle data; and
repeating the determination of the two or more scissor planes, the setting the two or more scissor plane registers, an the rendering of image data to the render buffer in response to a determination that the current visible rectangle data has changed as compared to the visible rectangle data;
wherein the rendering of image data to the render buffer comprises rendering only image data that corresponds to the two or more scissor planes, wherein two or more scissor plane registers comprise sixteen or more plane registers.

38. An article comprising a computer program product having stored therein instructions that, if executed, result in: receiving, via a graphic processing unit, visible rectangle data from a windows manager, wherein the visible rectangle data indicate the portions of a three dimensional (3D) application being displayed;
determining, via the graphic processing unit, two or more scissor planes based at least in part on the visible rectangle data;
setting, via the graphic processing unit, two or more scissor plane registers based at least in part on the determined two or more scissor planes; and
rendering, via the graphic processing unit, image data to a render buffer, wherein the rendering of image data is based at least in part on the two or more scissor plane registers.

39. The article of claim 38, wherein the rendering of image data to the render buffer comprises rendering only image data that corresponds to the two or more scissor planes.

40. The article of claim 38, wherein the instructions, if executed, further result in:
receiving, via the graphic processing unit, a render request from the 3D application; and
requesting, via the graphic processing unit, the visible rectangle data from the windows manager.

41. The article of claim 38, wherein the instructions, if executed, further result in:
receiving, via the graphic processing unit, current visible rectangle data from the windows manager; and
determining, via the graphic processing unit, whether the current visible rectangle data have changed as compared to the visible rectangle data.

42. The article of claim 38, wherein the instructions, if executed, further result in:
receiving, via the graphic processing unit, current visible rectangle data from the windows manager;
determining, via the graphic processing unit, whether the current visible rectangle data have changed as compared to the visible rectangle data;
transferring, via the graphic processing unit, the image data from the render buffer to a frame buffer in response to a determination that the current visible rectangle data has not changed as compared to the visible rectangle data; and
repeating the determination of the two or more scissor planes, the setting the two or more scissor plane registers, an the rendering of image data to the render buffer in response to a determination that the current visible rectangle data has changed as compared to the visible rectangle data.

43. An apparatus, comprising:
a graphic processing unit comprising two or more scissor plane registers, wherein the graphic processing unit is configured to:
receive visible rectangle data from a windows manager, wherein the visible rectangle data indicate the portions of a three dimensional (3D) application being displayed;
determine two or more scissor planes based at least in part on the visible rectangle data;
set the two or more scissor plane registers based at least in part on the determined two or more scissor planes; and
render image data to a render buffer, wherein the rendering of image data is based at least in part on the two or more scissor plane registers.

44. The apparatus of claim 43, wherein the rendering of image data to the render buffer comprises rendering only image data that corresponds to the two or more scissor planes.

45. The apparatus of claim 43, wherein the two or more scissor plane registers comprise eight or more plane registers.

46. The apparatus of claim 43, wherein the two or more scissor plane registers comprise sixteen or more plane registers.

47. The apparatus of claim 43, wherein the graphic processing unit is further configured to:
receiving a render request from the 3D application; and
requesting the visible rectangle data from the windows manager.

48. The apparatus of claim 43, wherein the graphic processing unit is further configured to:
receiving current visible rectangle data from the windows manager; and
determining whether the current visible rectangle data have changed as compared to the visible rectangle data.

49. The apparatus of claim 43, wherein the graphic processing unit is further configured to:
receiving current visible rectangle data from the windows manager;
determining whether the current visible rectangle data have changed as compared to the visible rectangle data; and
transferring the image data from the render buffer to a frame buffer in response to a determination that the current visible rectangle data has not changed as compared to the visible rectangle data; and
repeating the determination of the two or more scissor planes, the setting the two or more scissor plane registers, an the rendering of image data to the render buffer in response to a determination that the current visible rectangle data has changed as compared to the visible rectangle data.

50. A system comprising:
a render buffer;
a windows manager module; and
a graphic processing unit comprising two or more scissor plane registers, wherein the graphic processing unit is communicatively coupled to the render buffer and the windows manager module, and wherein the graphic processing unit is configured to:
receive visible rectangle data from the windows manager, wherein the visible rectangle data indicate the portions of a three dimensional (3D) application being displayed;
determine two or more scissor planes based at least in part on the visible rectangle data;
set the two or more scissor plane registers based at least in part on the determined two or more scissor planes; and
render image data to the render buffer, wherein the rendering of image data is based at least in part on the two or more scissor plane registers.

51. The system of claim 50, wherein the rendering of image data to the render buffer comprises rendering only image data that corresponds to the two or more scissor planes.

52. The system of claim 50, wherein the graphic processing unit is further configured to:
receiving a render request from the 3D application; and
requesting the visible rectangle data from the windows manager.

53. The system of claim 50, wherein the graphic processing unit is further configured to:
receiving current visible rectangle data from the windows manager;
determining whether the current visible rectangle data have changed as compared to the visible rectangle data; and
transferring the image data from the render buffer to a frame buffer in response to a determination that the current visible rectangle data has not changed as compared to the visible rectangle data; and
repeating the determination of the two or more scissor planes, the setting the two or more scissor plane registers, an the rendering of image data to the render buffer in response to a determination that the current visible rectangle data has changed as compared to the visible rectangle data.
